(19) United States
(12) Patent Application Publication
(10) Pub. No.: US 2022/0144672 A1
(43) Pub. Date: May 12, 2022

(54) SEAWATER TREATMENT AND INJECTION PLATFORM

(71) Applicant: Equinor Energy AS, Stavanger (NO)

(72) Inventors: Jostein SOGGE, Stjørdal (NO); Cecilie Gotaas JOHNSEN, Trondheim (NO); Arild SAMUELSBERG, Haugesund (NO)

(73) Assignee: Equinor Energy AS, Stavanger (NO)

(21) Appl. No.: 17/438,018

(22) PCT Filed: Mar. 9, 2020
(86) PCT No.: PCT/NO2020/050062

§ 371 Date: Sep. 10, 2021

(30) Foreign Application Priority Data
Mar. 12, 2019 (GB) 1903349.7

(51) Int. Cl. C02F 1/467; C02F 1/00

(52) U.S. Cl. CPC C02F 1/4674; C02F 2103/08; C02F 1/004

(57) ABSTRACT

A floating platform, preferably of the spar type, for treating seawater to provide prepared water for injection into a well extending through the seabed. The platform includes an elongate hull structure vertically position-able in a body of water such that the majority of the hull structure is submerged in the body of water, a deck secured to the top of the hull structure so that the deck lies above a surface of the body of water, and a chamber located within or substantially, within the hull structure so that the chamber is also submerged in the body of water and including a water inlet at a lower end of the chamber and a treated water outlet at an upper end, the chamber containing one or more cells for performing an anti-bacterial treatment on water passing up through the chamber from the inlet to the outlet. The platform further includes a pump for pumping water through the chamber from the inlet to the outlet through the cell or cells. In one configuration, the platform may be a spar platform.

### TECHNICAL FIELD

The present invention relates to a seawater treatment and injection platform and more particularly to such a platform that is of a spar type construction.

### BACKGROUND

A commonly used method of increasing the recovery rate from a petroleum reservoir involves the pumping of injection water into the petroleum reservoir. Injection is usually achieved via dedicated injection wells, increasing the reservoir pressure and causing an increased flow through the production wells.

Injection water may be so-called “produced water” which is separated from produced petroleum. Alternatively untreated water may be used, for example seawater. However, prior to the injection water being injected into a reservoir, it is desirable to treat the water mechanically to remove undesired particles from the injection water, and chemically or electrochemically, to prevent unintended effects of the water in the reservoir such as, for example, bacterial growth and corrosion.

It is known to use a process of electrochlorination to treat injection water. Electrochlorination involves flowing the seawater through cells which pass electric currents through the seawater. This is commonly carried out on floating platforms. It is necessary for the water to flow relatively slowly through the cells. This in turn requires that the chambers containing the cells be extremely large in order to generate sufficient treated water for injection. There are various alternatives to electrochlorination including purely chemical treatment processes such as the use of histidine-rich glycoprotein (HRG) cells. These cells create hypochlorite and hydroxyl radicals to kill bacteria. A combination of processes may be used, e.g. electrochlorination plus HRG. Regardless of the exact process used, exposure time) to chlorine) is key.

As is further discussed in WO2007035106, it is now known to place seawater treatment and injection plants for treating injection water on the seabed, for example at a well head. WO2007035106 recognises that the operation and maintenance of relatively large injection water filters installed on the seabed is relatively complicated and expensive. To avoid the need for filters the plant comprises a relatively large chamber into the bottom of which seawater is drawn. The water is allowed to flow slowly up the chamber. During this flow, relatively heavy particles settle out of the water, e.g. onto the seabed. Copper or other organic attracting materials may be located towards the top of the chamber in order to remove those lighter particles. Whilst the construction of WO2007035106 may reduce the need ford eep water operation and maintenance procedures, these still remain onerous and there remains a desire for platform based solutions.

### SUMMARY

According to a first aspect of the present invention there is provided a floating platform for treating seawater to provide prepared water for injection into a well extending through the seabed. The platform comprises an elongate hull structure vertically position-able in a body of water such that the majority of the hull structure is submerged in the body of water, a deck secured to the top of the hull structure so that the deck lies above a surface of the body of water, and a chamber located within or substantially within the hull structure so that the chamber is also submerged in the body of water and comprising a water inlet at a lower end of the chamber and a treated water outlet at an upper end, the chamber containing one or more cells for performing an anti-bacterial treatment on water passing up through the chamber from said inlet to set outlet. The platform further comprises a pump for pumping water through the chamber from said inlet to said outlet through said cell or cells. In one configuration, the platform may be a spar platform.

The platform may comprise one or more filtration units located on or in said deck, or within said hull, and being arranged to receive treated water from said outlet and to produce filtered water.

The platform may comprise a water injecting system for injecting filtered water provided by the filtration unit(s) into one or more injection wells located beneath the floating platform.

The platform may comprise a wind turbine mounted on said deck and being configured to provide electrical power to said cell(s) and to other components of the floating platform.

The chamber and the pump may be configured to provide said anti-bacterial treatment to water for at least one hour, preferably for at least 3 hours.

The cells may comprise electrochlorination cells, HRG cells, or a combination of both.

According to a second aspect of the present invention there is provided a method of treating seawater to provide prepared water for injection into a well extending through the seabed, the method being performed on an elongate hull structure vertically position-able in a body of water such that the majority of the hull structure is submerged in the body of water and having a deck secured to the top of the hull structure so that the deck lies above a surface of the body of water. The method comprises pumping water through a chamber located within or substantially within the hull structure and that is also submerged in the body of water, between a water inlet at a lower end of the chamber and a treated water outlet at an upper end, and, while the water is within the chamber, performing an anti-bacterial treatment process on the water.

### BRIEF DESCRIPTION OF THE DRAWINGS

FIG. 1 illustrates schematically a spar type structure incorporating a subsea treatment unit; and

FIG. 2 illustrates schematically a process for treating seawater for injection and using a the platform of FIG. 1.

### DETAILED DESCRIPTION

Despite the introduction of seabed plant for producing treated water, it remains desirable to instead locate this plant at or close to the water surface in order to reduce the operation and maintenance procedures.

Floating platforms of the spar or spar buoy type are well known. For example, EP0256177 describes a spar buoy construction including an elongated submerged hull with mooring lines connecting bottom portions of the hull with the sea bottom. The hull contains oil storage chambers and variable ballast chambers to establish and maintain a constant centre of gravity. This type of platform is used to store oil pumped into the storage chambers from subsea wells, via risers extending between the wells and the platform.

What is proposed here may represent a cost-efficient and environmentally appropriate solution to produce water for water injection in deep waters or similar. The idea is based on the spar solution where the bottom submerged section of the spar (submerged at a depth of around 150 m or more below sea-level) contains a deck space (grated or similar) configured to contain a number of utilities including seabox elements to remove bacteria from seawater by electrochlorination and/or other process. The extremely large volume available for these utilities means that the water can flow very slowly through the treatment cells, in turn meaning that this purification stage is very effective. The partly purified water is then pumped topside on the spar, where a number of filtration stages are arranged to remove sulphur and other salts depending on the required purity and quality for the water. The purified seawater is then routed to a water injection pump meeting the required reservoir pressure for pressure support.

Due to the deep pre-treatment solution however, chemical cleaning, cleaning-in-place (CIP) and other cleaning methods can be avoided. T his contributes to reducing operation and maintenance operations opening up the possibility of unmanned operation of such a utility spar platform.

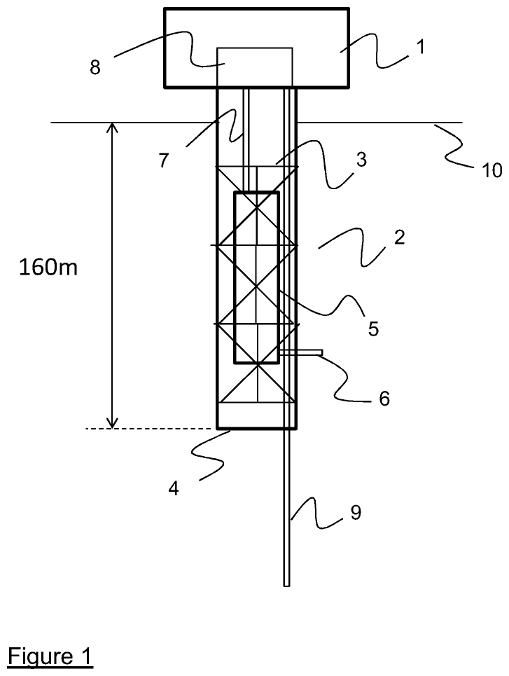

FIG. 1 illustrates schematically a spar type platform configured to produce injection water and to inject the water into injection wells. The spar comprises a deck 1 sitting above the water level 10 on top of an elongated spar frame 2. The spar frame may have a generally known construction comprising a framework of metal girders 3. The weight and centre of mass of the platform is such that it remains in a substantially vertical orientation. The bottom 4 of the spar may sit at a depth of 160 m or thereabouts.

Located within the space of the spar framework is a chamber 5. Although the chamber 5 is shown in FIG. 1 as being generally rectangular, it may of course take any suitable shape and may indeed comprise multiple sub-chambers. A n irregular shape and construction may be desirable to maximise the chamber volume within the framework. The chamber 5 contains units for performing chlorination of seawater, e.g. electrochlorination, HRG treatment, or some other anti-bacterial process that requires prolonged treatment of the water. Seawater is drawn into the chamber via an inlet 6 located at the bottom of the chamber. Seawater flows slowly up through the chamber during which time it passes through the cells where chlorination is performed. The pre-treated water exits the chamber via an outlet 7 which conducts the seawater to units 8 located on the deck 1. A s discussed above, units 8 on the deck, connected to the chamber outlet 7, may perform filtration operations to remove sulphur and other salts. The treated water is then injected into the injection well(s) via a conduit 9 which may take any suitable form.

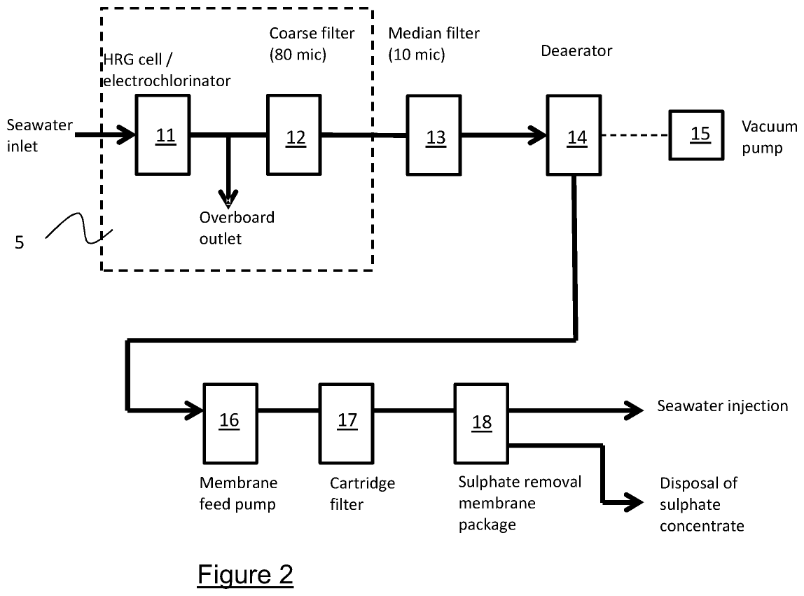

FIG. 2 illustrates a process flow for generating injection water from seawater. The process is conventional except insofar as the chlorination cells 11 (HRG cell/electrochlorinator) and coarse filter 12 are located in the subsea chamber 5 of the platform of FIG. 1. The median filter 13 which is located downstream of the coarse filter may also be located subsea or may be located on the platform deck. Conventional components which are located upstream of the median filter include a dearator 14 driven for example by a vacuum pump 15, membrane feed pump 16, cartridge filter 17, and sulphate removal membrane package 18, out of which flows the injection water and water containing concentrated sulphate which is dumped back into the sea. It will be appreciated however that this flow, and the components utilised, may be varied. In particular, due to the very high effectiveness of the treatment process performed in the spar, which allows for very long exposure of the seawater to the anti-bacterial process, certain downstream components may be omitted or simplified.

The spar type construction of the seawater treatment and injection platform described here lends itself to being powered by some alternative energy generating means such as a wind turbine. F or example, the platform may utilise principles of the Equinor™ Hywind™ design which is a floating wind turbine design based on a single floating cylindrical spar buoy moored by cables or chains to the sea bed. Its substructure is ballasted so that the entire construction floats upright. A wind turbine such as the Hywind turbine may be integrated into the spar design or may be located beside the injection spar platform with cables conducting electricity from the wind turbine to the injection platform.

It will be appreciated by the person of skill in the art that various modifications may be made to the above described embodiments without departing from the scope of the present invention.

1. A floating platform for treating seawater to provide prepared water for injection into a well extending through the seabed, the floating platform comprising:
an elongate hull structure vertically position-able in a body of water such that a majority of the hull structure is submerged in the body of water;
a deck secured to a top of the hull structure so that the deck lies above a surface of the body of water;
a chamber located within or substantially within the hull structure so that the chamber is submerged in the body of water, the chamber comprising a water inlet at a lower end of the chamber and a treated water outlet at an upper end of the chamber, the chamber containing one or more cells for performing an anti-bacterial treatment on water passing up through the chamber from said inlet to said outlet; and
a pump for pumping water through the chamber from said inlet to said outlet through said one or more cells.

2. The floating platform according to claim 1, further comprising one or more filtration units located on or in said deck, or within said hull, the one or more filtration units being arranged to receive treated water from said outlet and to produce filtered water.

3. The floating platform according to claim 1, further comprising a water injecting system for injecting filtered water provided by the one or more filtration units into one or more injection wells located beneath the floating platform.

4. The floating platform according to claim 1, further comprising a wind turbine mounted on said deck and being configured to provide electrical power to said one or more cells and to other components of the floating platform.

5. The floating platform according to claim 1, the platform being a spar platform.

6. The floating platform according to claim 1, said chamber and said pump being configured to provide said anti-bacterial treatment to water for at least one hour.

7. The floating platform according to claim 1, wherein said one or more cells comprise electrochlorination cells, HRG cells, or a combination of both.

8. A method of treating seawater to provide prepared water for injection into a well extending through the seabed, the method being performed on an elongate hull structure vertically position-able in a body of water such that a majority of the hull structure is submerged in the body of water and having a deck secured to a top of the hull structure so that the deck lies above a surface of the body of water, the method comprising:
pumping water through a chamber located within or substantially within the hull structure, the chamber being submerged in the body of water, between a water inlet at a lower end of the chamber and a treated water outlet at an upper end of the chamber; and
while the water is within the chamber, performing an anti-bacterial treatment process on the water.

9. The floating platform according to claim 1, said chamber and said pump being configured to provide said anti-bacterial treatment to water for at least 3 hours.
